(19) United States
(12) Patent Application Publication
(10) Pub. No.: US 2011/0040579 A1
(43) Pub. Date: Feb. 17, 2011

(54) WEB-BASED SYSTEMS AND METHODS FOR PROVIDING SERVICES RELATED TO AUTOMOBILE SAFETY AND AN INSURANCE PRODUCT

(75) Inventor: James Havens, Mill Creek, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: SAFECO INSURANCE COMPANY OF AMERICA, Seattle, WA (US)

(21) Appl. No.: 11/959,749

(22) Filed: Dec. 19, 2007

Related U.S. Application Data
(60) Provisional application No. 60/871,077, filed on Dec. 20, 2006.

(51) Int. Cl. G06Q 40/00

(52) U.S. Cl. 705/4

(57) ABSTRACT

Systems and methods provide services relating to driving safety and insurance in connection with insuring selected segments of a population, such as young drivers or elderly drivers. A web-based system provides a web site having a home web page configured to provide links to web pages accessible by a user over the Internet, configured to provide program elements such as an interface to a GPS vehicle monitoring system connected to provide vehicle information to the user via one or more of the web pages and to receive instructions from the user to select features of the GPS system, a display of or link to educational information relating to safe driving, stored by the web-based system or provided by interface to a third party web site; or a display of or link to a tool providing an estimate of an insurance premium discount based on use of the program. A system for providing an insurance price estimate, a computer-implemented method of promoting the sale of vehicle insurance to a population segment, a computer system for providing an insurance premium discount, and a computer program product are also provided.

### CROSS REFERENCE TO RELATED APPLICATION

This application claims the benefit of U.S. Provisional Patent Application Ser. No. 60/871,077 entitled, “Young Driver Program,” filed Dec. 20, 2006, the contents of which are hereby incorporated herein by reference in their entirety.

### FIELD OF THE INVENTION

The present invention relates to an Internet based system for providing services related to automobile safety and automobile insurance.

### BACKGROUND ART

Some segments of the automobile driver population are more likely than the norm to become involved in accidents or otherwise drive unsafely. This is of concern to persons close to such drivers, such as family members, and insurance companies who consider covering such drivers for liability and property damage in a range of know automobile insurance policies, to employers of such drivers, and to the general public both in terms of general safety and in terms of the cost to the general public of health care and insurance. One group of such drivers consists of young drivers, which may be defined to include drivers between the ages of 15 and 24. Another group is elderly drivers. Another group is commercial fleet drivers.

Past efforts, mostly piecemeal in nature, have been made to improve the performance of young drivers. For example, some jurisdictions require driver education, and insurance companies often reduce rates based on driver education courses or maintaining a safe driving record.

However, there has been a need for an Internet based, comprehensive approach to improving safety and accountability of young drivers and other segments of the driver population.

### SUMMARY OF THE INVENTION

The present invention provides systems and methods for providing services relating to driving safety and insurance. Various embodiments provide such services in connection with insuring selected segments of a population, for example, without limitation, young drivers, elderly drivers, or commercial fleet drivers.

Various embodiments of the present invention provide a system, program, and method for enhancing the new driver experience for young drivers and their parents, guardians, and/or policyholders by providing tools to encourage young drivers to drive safely and bundling useful resources and services that significantly improve the lifestage transition on topics of interest to young drivers and their parents, guardians, and/or policyholders. As used herein, “policyholder” refers generally to any person (e.g., friend, relative, employer, or business entity) that holds an automobile insurance policy that covers the young driver. According to various embodiments, the program provides: (1) a drivers' education course for young drivers; (2) a global positioning satellite (GPS) system to be installed within the young driver's vehicle that allows the young driver's driving behavior to be monitored, the young driver's vehicle to be tracked, the doors to be unlocked remotely, and/or an alert to be sent if the vehicle is operated without authorization or outside of a predefined geofence; (3) a rewards program for rewarding young drivers for safe driving behavior or for participation or achievements related to various elements of the young driver program during a particular time period; (4) online resources to provide young drivers and their parents, guardians, and/or policyholders with information relating to the driving experience; (5) an accident scene management plan; and/or (6) a roadside assistance plan. For example, in one embodiment, the online resources may include an insurance price optimizer tool for existing or potential insurance customers, a car research tool, articles providing recommendations for safe cars, information about safety features in vehicles, and/or local and state driving laws.

A system providing a young driver program containing selected ones of the features described above may be accessed by users via a website comprising various webpages. These webpages may, for example, include a home page and other pages relating to a car research tool, access to an interface for an insurance price optimizer tool, access an interface to a GPS system, information related to the young driver rewards program, additional online resources related to the driving experience, and information about a drivers' education course.

Generally described, in various embodiments the present invention provides a web-based system for providing services related to automobile safety and an insurance product, comprising a web site comprising a home web page configured to provide links to one or more web pages accessible by a user over the Internet, the one or more web pages being configured to provide at least two elements selected from an interface to a GPS vehicle monitoring system connected to provide vehicle information to the user via one or more of the web pages and to receive instructions from the user to select features of the GPS system; at least one of a display of or link to educational information relating to safe driving, stored by the web-based system or provided by interface to a third party web site; or at least one of a display of or link to a tool providing an estimate of an insurance premium discount based on use of the web pages. Optionally, the elements from which the at least two elements are selected may further include an interface to a rewards program based on compliance with driver behavioral standards, and compliance may include one or more of: use of one or more of the web pages; use of the GPS system, or compliance with a driver safe behavior agreement. The elements from which the at least two elements are selected may further include at least one of a display of or link to guidelines for driver behavioral standards; an interface to a drivers education course provider; or an interface to a roadside assistance system.

In an embodiment of the present invention, the GPS system is configured for providing third parties, insurance companies, and/or program participants with information relating to a location of a vehicle, providing an ability to unlock a door of the vehicle remotely, and providing an alert if the vehicle travels outside of a predefined geofence or is operated without authorization. The GPS system may include a GPS receiving system linked to the vehicle over a network and configured to receive data from the vehicle and to display a map of the vehicle's position.

In an embodiment of the present invention, the premium discount increases in proportion to the level of use of the elements by a driver, a driver's parent, guardian, and/or a policyholder. In alternative embodiments, the premium discount may depend on the combination of elements utilized by a driver, a driver's parent, guardian, and/or a policyholder, or on the particular one or more elements utilized by a driver, a driver's parent, guardian, and/or a policyholder. The tool for estimating a premium may include an interface for receiving user information useful for calculating an insurance premium and an insurance premium calculator.

An embodiment of the present invention provides a system for providing an insurance price estimate, comprising an interface for receiving user information used for calculating an insurance premium, the user information including presence or absence of user participation in a plurality of elements of a driver program, the program elements including one or more of: driving safety information, an accident scene management plan, a roadside assistance plan, a car research tool, a driver education course, a safety rewards program, or a GPS data gathering system; a computer based pricing tool configured to output an estimated insurance premium based on the user information; and a user accessible display of the estimated insurance premium output by the pricing tool. In one exemplary embodiment, the pricing tool is configured to store discount percentages attributed to participation is each of the elements of the driver program, and to vary the estimated premium based a sum of the discounts associated with the elements in which the user participates. In an alternative exemplary embodiment, the pricing tool applies a premium discount according to the number of program elements in which the user participates.

An embodiment of the present invention provides a computer-implemented method of promoting the sale of automobile insurance policies written on a selected segment of a population, the method comprising the steps of providing a user interface via a network a driver program running on a computer system, the program providing for one or more drivers from a selected segment of a population (1) an interface to a monitoring system configured for collecting data associated with a vehicle to be driven by one of the one or more drivers; and (2) one or more online resources for providing information relating to driving by the selected segment of the population; and in response to participation by one of the drivers in the program, providing an estimated premium discount to a customer for an insurance policy on the driver, wherein the customer may be the driver or a third party. In an embodiment of the present invention, the estimated premium discount is provided responsive to participation in the program by a family member, guardian, or a policyholder associated with the driver.

An embodiment of the present invention provides a computer program product, comprising a computer readable medium having recorded thereon computer executable instructions for providing a user interface via a network a driver program running on a computer system, the program providing for one or more drivers from a selected segment of a population (1) an interface to a monitoring system configured for collecting data associated with a vehicle to be driven by one of the one or more drivers; and (2) one or more online resources for providing information relating to driving by the selected segment of the population; and in response to participation by one of the drivers in the program, displaying an estimated premium discount for an insurance policy on the driver. The selected segment of the population may be persons 15 through 24 years of age. In an embodiment of the present invention, the program includes a drivers' education course for drivers; a rewards program that rewards drivers for safe driving habits or for participation or achievements related to various parts of the driver program; an accident scene management plan; and a roadside assistance plan. The online resources may comprise an insurance price optimizer tool configured to provide ways to reduce the cost of automobile insurance for drivers; a car research tool configured to identify costs associated with owning or leasing one or more types of vehicles; and one or more articles relating to driver safety.

In various embodiments of the invention, an insurance company may offer a premium discount if a young driver and his or her parent, guardian, and/or policyholder participate in the young driver program. In one embodiment, the premium discount may encourage participation in the young driver program by young drivers and their parents, guardians, and/or policyholders. In a particular embodiment in which an insurance company sponsors the young driver program, the increased participation in the young driver program may increase the share penetration of the insurance company within the young driver segment and the number of policies written within this segment. In addition, participation in the program, according to one embodiment, may promote safer driving habits, safer vehicle choices, and more informed drivers, which may reduce the risk to the insurance company of insuring young drivers. In another embodiment, the sponsor of the young driver program may offer participants a discount on the cost of purchasing or leasing a car for participating in the young driver program. A customer eligible for the discount may be an existing or a potential policyholder.\

In one embodiment of the invention, a predetermined premium discount is applied by the customer's insurance provider when the insured vehicle has a GPS unit installed, or when the unit is installed and activated for monitoring. A computer system for providing an insurance premium discount may be provided, comprising an underwriting and rating module configured to receive from a monitoring system in communication with an insured vehicle data indicating whether the vehicle has installed therein a monitoring device for sending information to the monitoring system; and apply a discount to the customer's premium in response to confirmation of installation of monitoring device. Both installation and activation of the monitoring device may be required for application of the discount. The data from the monitoring system may be received by the underwriting and rating module indirectly from a data storage device of a server that receives and stores the data. The system may include an interface for receiving a request for a discounted insurance premium from a customer. In an alternative embodiment, the discount may be applied to the customer's premium automatically without receipt of a request for the discount.

It should be understood that features and elements of a driver program according to the present invention as described herein, using a young driver program as an exemplary embodiment, can be applied to other segments of a population, such as elderly drivers or commercial fleet drivers. Similarly, reference to a parent or guardian may apply to an employer when the segment of a population is a group of commercial drivers.

### BRIEF DESCRIPTION OF THE DRAWINGS

Having thus described the invention in general terms, reference will now be made to the accompanying drawings, which are not necessarily drawn to scale, and wherein:

FIG. 1 is a schematic diagram illustrating various elements of the young driver program according to various embodiments of the invention and provided according to some of such embodiments by way of a website over the Internet.

FIG. 2A is a flowchart generally illustrating a method of providing a premium discount for participation in the young driver program according to one embodiment of the invention.

FIG. 2B is a flowchart illustrating in more detail a computer implemented method of providing a premium discount for participation in the young driver program based on elements of the young driver program used, according to the embodiment of the invention illustrated in FIG. 2.

FIG. 3A is a flowchart generally illustrating a method of providing a premium discount for participation in the young driver program according to another embodiment of the invention.

FIG. 3B is a flowchart illustrating in more detail a computer implemented method of providing a premium discount for participation in the young driver program based on the combination of elements of the young driver program used, according to the embodiment of the invention illustrated in FIG. 3.

FIG. 4 is a flowchart illustrating a method of providing a discount for the cost of a car for participation in the young driver program according to another embodiment of the invention.

FIG. 5 is a graphic illustration of an exemplary webpage presenting links to various elements of a young driver program according to a particular embodiment of the invention.

FIG. 6 is a graphic illustration of an exemplary webpage providing results of a vehicle search according to a particular embodiment of the invention.

FIG. 7 is a graphic illustration of an exemplary webpage for inputting criteria potentially relevant to a cost of insurance for a vehicle according to a particular embodiment of the invention.

FIG. 8 is a graphic illustration of an exemplary webpage for providing results of a search for an estimated cost of insurance based on the criteria input into the dialog window shown in FIG. 7 according to one embodiment of the invention.

FIG. 9 is a graphic illustration of an exemplary webpage for providing information on a drivers' education course according to one embodiment of the invention.

FIG. 10 is a graphic illustration of an exemplary webpage for providing information regarding the GPS system according to one embodiment of the invention.

FIG. 11 is a graphic illustration of an exemplary webpage for inputting criteria relevant to the GPS system according to one embodiment of the invention.

FIG. 12 is a graphic illustration of an exemplary webpage for viewing a location of a vehicle being tracked by a GPS system according to one embodiment of the invention.

FIG. 13 is a graphic illustration of an exemplary webpage for viewing a history log of a vehicle being tracked by a GPS system according to one embodiment of the invention.

FIG. 14 is a graphic illustration of an exemplary webpage for viewing a location of a vehicle that includes a GPS system according to one embodiment of the invention.

FIG. 15 is a graphic illustration of an exemplary webpage for providing information about a rewards program according to one embodiment of the invention.

FIG. 16 provides a block diagram of a system for managing a young driver program and underwriting insurance in accordance with exemplary embodiments of the invention;

FIG. 17 is a schematic block diagram of the insurance provider server in accordance with exemplary embodiments.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

Various embodiments of the invention are directed to providing a young driver program 100 that enhances the new driver experience for young drivers (e.g., between the ages of 15 and 24) and their parents, guardians, and/or policyholders by providing tools to encourage young drivers to drive safely and consolidating information on topics of interest to young drivers and their parents, guardians, and/or policyholders. In one embodiment, the program is sponsored by an insurance company, and in another embodiment, the program is sponsored by a third party. In an embodiment in which a third party sponsors the program, multiple insurance companies may partner with the third party or may provide benefits to policyholders that participate in the program. The program may be provided for other selected segments of a population.

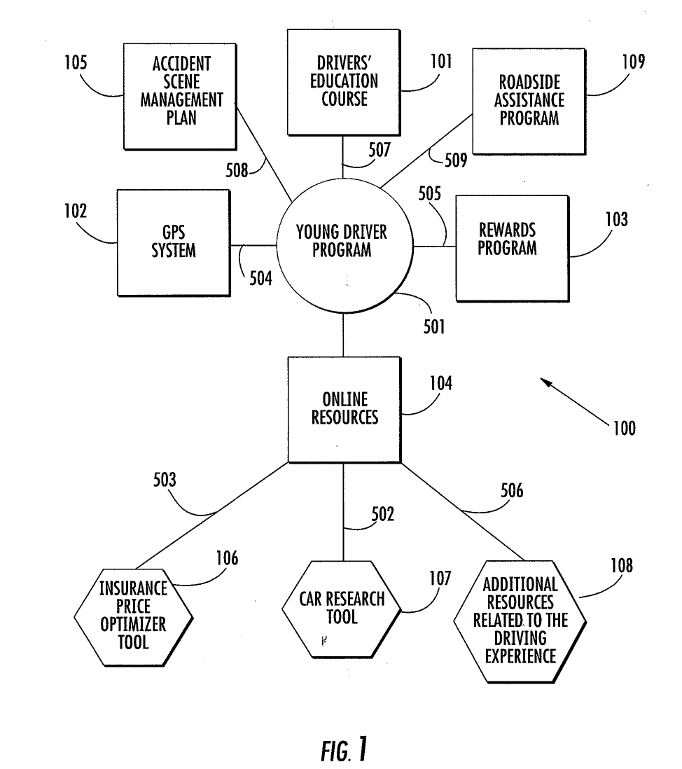

FIG. 1 illustrates various aspects of the young driver program 100 according to one embodiment of the invention. These aspects may be provided to an online user connected to a young driver home page 501 and related web pages described in more detail below. The user may be, for example, without limitation, a young driver, a parent or guardian of the young driver, or a customer of insurance, who may be an existing policyholder or a potential policyholder. In particular, the young driver program 100 provides: (1) a drivers' education course 101 for young drivers; (2) a global positioning satellite (GPS) system 102 to be installed within the young driver's vehicle that allows the young driver's driving behavior to be monitored, the young driver's vehicle to be tracked, the doors to be unlocked remotely, and/or an alert to be sent if the vehicle is operated without authorization or outside of a predefined geofence; (3) a rewards program 103 for rewarding young drivers for safe driving behavior or for participation or achievements related to various elements of the young driver program 100 during a particular time period; (4) online resources 104 to provide young drivers and their parents, guardians, and/or policyholders with information relating to the driving experience; (5) an accident scene management plan 105; and/or (6) a roadside assistance plan 109. For example, in one embodiment, the online resources 104 include an insurance price optimizer tool 106, a car research tool 107, and additional resources 108 related to the driving experience. According to one embodiment, additional resources 108 may include, for example, recommendations for safe cars, information about safety features in vehicles, and local and state driving laws.

In various embodiments, an insurance company may offer a premium discount if the young driver and his or her parent, guardian, and/or policyholder participate in the young driver program 100. The premium discount may encourage participation in the young driver program 100 by young drivers and their parents, guardians, and/or policyholders, according to various embodiments. In addition, in a particular embodiment in which an insurance company sponsors the young driver program 100, the increased participation in the young driver program 100 may increase the share penetration of the insurance company within the young driver segment and the number of policies written within this segment. Furthermore, participation in the program 100, according to one embodiment, may promote safer driving habits, safer vehicle choices, and more informed drivers, which may reduce the risk to the insurance company of insuring young drivers. In another embodiment, the sponsor of the young driver program 100 may offer participants a discount on the cost of purchasing or leasing a car for participating in the young driver program 100.

According to various embodiments, the amount to be discounted depends on the level of participation in the young driver program 100 by the young driver and his or her parent, guardian, and/or policyholder. In particular, in one embodiment in which the insurance company provides premium discounts based on participation in the program 100, the insurance company may associate a particular discount amount with each element of the program 100. The premium discount provided to the policyholder is the sum of the particular discount amounts earned for participation in various elements of the young driver program 100. For example, in one embodiment, a 0.5% discount may be associated with utilizing the online resources 104, a 3% discount may be associated with taking the drivers' education course 101, and a 5% discount may be associated with installing the GPS system 102. If the young driver and his or her parent, guardian, and/or policyholder participate in all three, the premium discount is 8.5%. However, if the young driver does not take the drivers' education course 101 but participates in the other two elements, for example, the premium discount is 5.5%.

In another embodiment of the invention, the insurance company applies a flat discount, for example a predetermined percentage, to a customer's premium on confirmation that the insured vehicle has installed therein a GPS unit. In the alternative, both installation and activation of the GPS unit for monitoring are required for the discount. The discount may be applied on issuance of the policy, or may be refunded to a customer who utilizes the GPS system during a policy term, either in total or on a pro-rata basis based on the remaining policy term.

In another embodiment, the insurance company may associate a particular discount amount with certain combinations of elements of the program 100. For example, the insurance company may offer a 5% discount if the young driver and/or his or her parent, guardian, and/or policyholder participate in two of six available elements of the program 100 or an 8% discount if the young driver and/or his or her parent, guardian, and/or policyholder participate in four of eight available elements of the program 100.

In yet another embodiment, the sponsor of the young driver program 100 may provide a discount for car purchases or leases made by participants of the young driver program 100. Similar to the embodiments described above regarding offering premium discounts for participation in the program 100, the amount of the discount for purchasing or leasing a car is based on the level of participation in the young driver program 100, according to one embodiment.

Several aspects of the young driver program 100 according to various embodiments of the invention are described in more detail below.

### Installation of GPS System

According to various aspects of the invention, the young driver program 100 provides a GPS system 102 that includes a GPS unit for installing in a young driver's vehicle and a GPS receiving system (e.g., a computing device external to the vehicle) for receiving signals from the GPS unit. The GPS system 102 may be used in a variety of ways to encourage responsible and safe driving by young drivers. In a particular embodiment, the GPS system 102 used by the young driver program 100 may be provided by Seaguard Electronics, LLC, of Irvine, Calif., or Mobile Angel (see www.mobileangelgps.net). Similar systems are described in U.S. Pat. Nos. 6,442,241; 6,643,355; 6,973,166; and 5,898,391, each of which is incorporated herein by reference in its entirety.

According to various embodiments, the GPS system 102 once installed and activated by setting up a connection between the GPS vehicle unit and the GPS receiving system may collect data related to how fast the young driver drives, whether the vehicle is driven during certain times of the day or on certain days of the week, whether the vehicle is driven outside of a predefined geographical area (i.e., geofence), and/or whether the vehicle is operated without authorization. In addition, this data may be communicated to the parent, guardian, and/or policyholder to allow the young driver's driving behavior and activity to be monitored. In an embodiment in which the insurance company sponsors the program 100, the data may be communicated to the insurance company. And, in a further embodiment in which a third party sponsors the young driver program 100, this data may be communicated to the insurance company issuing the automobile insurance policy for the young driver and/or the third party sponsor.

In another embodiment, the GPS system 102 may be used to alert certain parties when the vehicle is operated without authorization, such as when the vehicle has been stolen or when the vehicle is operated during times of the day in which the young driver is not authorized to drive or is operated outside a permitted geographical area. For example, in various embodiments, the alert is sent to the parent, guardian, and/or policyholder. In another embodiment in which the insurance company sponsors the program 100, the alert may be sent to the insurance company. And, in yet another embodiment in which a third party sponsors the program 100, the alert may be sent to the third party sponsor and/or the insurance company issuing the automobile insurance policy for the young driver.

According to various embodiments of the invention, the GPS system 102 may also be used to unlock the vehicle remotely when keys are unavailable to an authorized person. In addition, in one embodiment, the GPS system 102 may be configured to create and store a history log of vehicle data captured by the GPS system 102 (e.g., time-stamped speed data, location data, or data relating to whether the driver was violating a rule set by a parent, guardian, policyholder, insurance company, and/or third party program sponsor) and/or a service log for the vehicle. In addition, the GPS system 102 may be further configured to provide the driver with notice (e.g., posting on webpage, email, telephone call, text message, or facsimile) that maintenance is suggested or needed based on a maintenance log. In another embodiment, the GPS system 102 may be configured for detecting when the battery of the GPS unit is low and notifying the driver if the battery is low. Furthermore, in another embodiment, the GPS system 102 may be further configured for causing the vehicle to flash the lights and honk the horn in response to a signal from a remote location. In yet another embodiment, the GPS system 102 may be configured to enable the starter of the vehicle and/or disable the starter from a remote location.

In various embodiments, the young driver program 100 allows the parent, guardian, policyholder, the third party program sponsor, and/or the insurance company to establish rules or guidelines related to the young driver's driving activities that can be monitored by the GPS system 102. In response to one or more of the rules being violated, the GPS system 102 is configured for sending an alert to one or more particular parties (e.g., the parent, guardian, policyholder, the sponsor of the program 100, and/or the insurance company). For example, in one embodiment, the young driver program 100 provides a website, such as, for example, as part of the online resources 104 in FIG. 1, that allows the parent, guardian, and/or policyholder of the young driver to define a geofence (i.e., one or more geographical areas) within which the young driver is permitted to drive and specify that the GPS system 102 should notify the parent, guardian, and/or policyholder if the young driver drives outside of the geofence. Alternatively, in another embodiment, the geofence may be defined by the insurance company or the third party sponsor, and the insurance company or the third party sponsor may specify that the GPS system 102 should notify the insurance company, the third party sponsor, and/or the parent, guardian, and/or policyholder if the vehicle moves outside of the geofence. A warning alarm or display may also be installed in the vehicle to alert the young driver when a rule is violated, allowing an opportunity for immediate correction.

A geofence is commonly known to be a user-defined geographical region, and, typically, passage into or out of the geographical region is detected by a GPS device. In various embodiments, passage into or out of the region triggers an event, such as a notification sent to an interested party. For example, various exemplary systems for defining a geofence and providing a notification system for movement outside of the geofence are described in www.gpsreview.net/category/geofencing, which is herein incorporated by reference in its entirety.

In addition, according to various embodiments of the invention, the GPS system 102 may be used to monitor the speed of the driver and alert the driver if the driver exceeds a preset maximum speed limit. For example, in one embodiment, the preset maximum speed limit may be set by the parent, guardian, policyholder, the insurance company, and/or third party program sponsor. In another embodiment, a rule may be set regarding a time period in which a young driver is allowed to drive the vehicle (e.g., after 7 am and before 9 pm). If this rule is violated, the GPS system 102 may notify the parent, guardian, policyholder, insurance company, and/or third party program sponsor of the violation. In another embodiment, the GPS system 102 may notify the young driver, and in yet another embodiment, the GPS system 102 may disable the ability to start the vehicle outside of the allowed time frame.

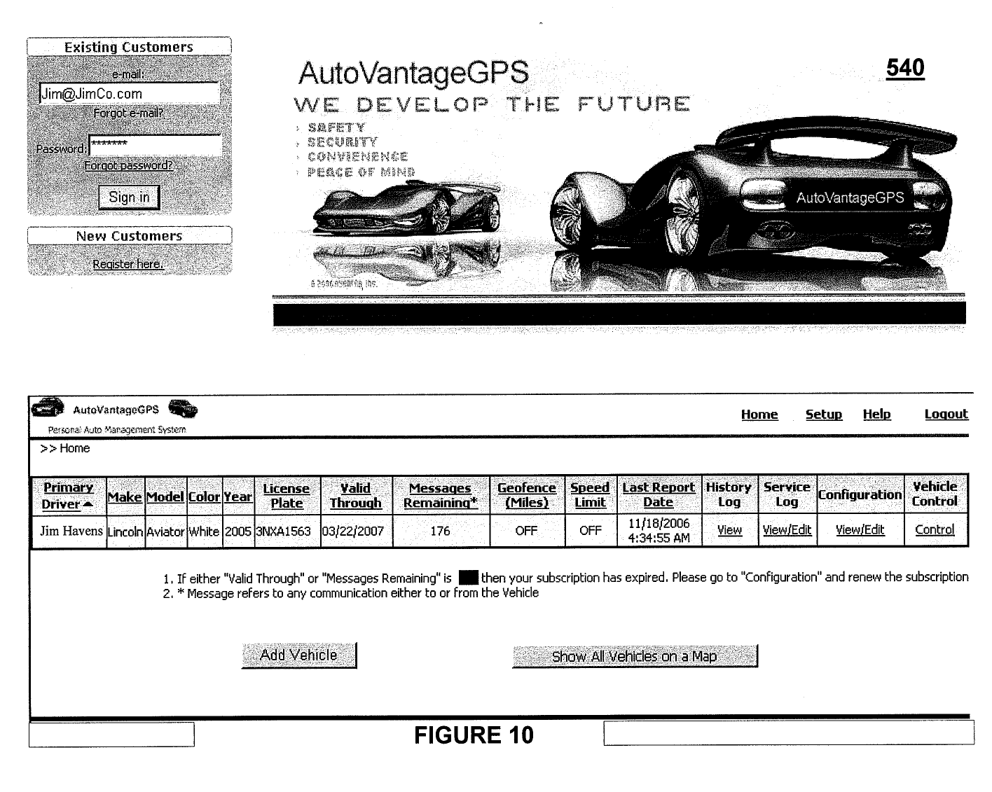

In one embodiment, the rules or guidelines may be defined using a website accessible through an Internet connection, and data collected by and/or notifications resulting from the data may be displayed on the website, such as the website described in FIGS. 10-14.

### Rewards Program for Safe Driving Record

In various embodiments, the young driver program 100 also allows the parent, guardian, policyholder, third party program sponsor, and/or insurance company to establish incentives or rewards for desirable actions by the young driver. Various embodiments of the invention provide a rewards program 103 as part of the young driver program 100 to reward young drivers for desirable behavior. For example, in one embodiment, the rewards program 103 may award points to the young driver, and accumulated points may be redeemed by the young driver for various items, such as, for example, gas, coffee, music, or retail items. In addition, in another embodiment, the accumulated points may be redeemed for gift cards that can be used to purchase various items. In yet another embodiment, the accumulated points may be used to obtain goods and/or services from a catalog.

In addition, according to various embodiments, desirable behaviors that are rewarded may include staying within the pre-defined geofence, abiding by the rules set by the young driver's parent, guardian, policy holder, insurance company, and/or third party program sponsor, being accident free, not receiving a traffic violation ticket during the particular time period (e.g., a month, or a policy period), and/or participating in various other elements of the young driver program 100.

In one embodiment of the invention, the rewards program may incorporate features available under the trademark Loyaltyworks Advantage.

### Participation in a Drivers' Education Program

In various embodiments of the invention, the young driver program 100 provides a drivers' education course 101 in which young drivers can participate. In one embodiment, the driver's education course 101 offered is co-branded by the sponsor of the young driver program 100 and a drivers' education course provider. Participation in the co-branded course 101 would satisfy a requirement to participate in this element of the young driver program 100. For example, in one embodiment, the sponsor may partner with Sears, which offers drivers' education courses in multiple states within the U.S., to offer drivers' education courses 101 as part of the young driver program 100.

In another embodiment, the drivers' education course may be a course offered by a third party if judged adequate by the sponsor of the young driver program 100. For example, the course may be offered locally to the young driver, and upon completing the course, the young driver may request that the course be approved to count towards the young driver's participation in the young driver program 100. Furthermore, in yet another embodiment, drivers' education courses that satisfy this element of the young driver program 100 would have to be pre-approved by the sponsor of the young driver program 100. In another embodiment, the young driver may earn reward points for participation in the drivers' education course under the rewards program 103.

According to various embodiments, the drivers' education course 101 may be an entry level course or an advanced level course. In an embodiment in which the course 101 is an advanced level course, the course may teach car control techniques, reinforce the relationship between speed and stopping distance, accident avoidance, and/or surviving modern distractions.

### Online Resources for Young Drivers and Policyholders

Various embodiments of the invention provide to young drivers and their parents, guardians, and/or policyholders online access to information relating to the driving experience through one or more online resources 104, such as websites. For example, in various embodiments, the information may include one or more of the following types of information: (1) a car research tool 107 that allows a user to review various types of cars for safety, reliability, historic depreciation, style/aesthetic preferences, fuel economy, cost-to-buy or lease, cost to insure, and cost to own (e.g., average or estimated fuel costs and repair costs); (2) additional resources related to the driving experience 108, such as articles providing information on cars that are safe and/or reliable, information regarding safety features offered in vehicles, information regarding local and state traffic laws, and/or information on safe driving tips; and/or (3) an insurance price optimizer tool 106 that allows a user to compare how various factors affect insurance rates, such as, for example, the type of car driven, the number and age of the drivers, good grades of the drivers, safe driving records for the drivers, policy coverages, limits, and deductibles, and/or participation in one or more elements of the young driver program 100. Furthermore, in one embodiment, the online resources 104 may be provided directly by a website associated with the young driver program 100. In another embodiment, one or more of the resources 104 may be provided through links to other websites that are included on a young driver program 100 website. In another embodiment, the young driver may earn reward points for participation one or more of the online resources 104.

### Various Additional Tools and Resources

Various other embodiments of the invention provide additional tools and resources to enhance the young driver experience. For example, in one embodiment, the young driver program 100 provides an accident scene management plan 105 includes, for example, a service that determines that an accident has occurred, identifies the location of the accident, and dispatches a tow truck to tow the vehicle to a nearby repair or storage facility. In addition, the plan 105 may be offered by a third party or by the insurance company according to various embodiments. Furthermore, the young driver program 100 may offer a roadside assistance plan 109, such as, for example, the roadside assistance plans offered by AAA or Cross Country Automotive Services or a similar plan offered by the insurance company, and/or an Accident Preparedness Kit, which, in one embodiment, includes instructions on what to do in case of an accident and a disposable camera to document the accident scene.

### Premium Discount for Participation in the Young Driver Program

According to various embodiments of the invention, an insurance company may offer premium discounts to young drivers and/or their policyholders that participate in the young driver program 100. In one embodiment, the premium discount may encourage participation in the young driver program 100 by young drivers and their parents, guardians, and/or policyholders. In a particular embodiment in which an insurance company sponsors the young driver program 100, the increased participation the young driver program 100 may increase the share penetration of the insurance company within the young driver segment and the number of policies written within this segment. In addition, participation in the program, according to one embodiment, may promote safer driving habits, safer vehicle choices, and more informed drivers, which may reduce the risk to the insurance company of insuring young drivers.

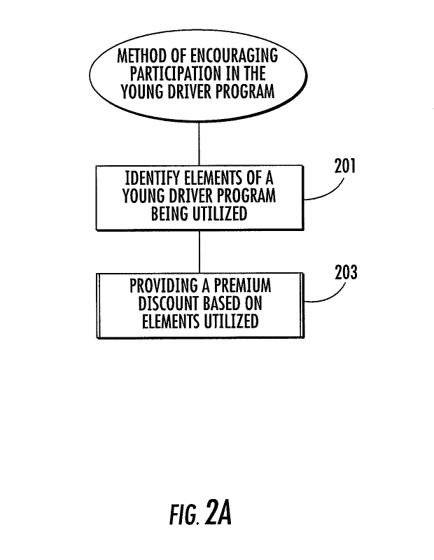

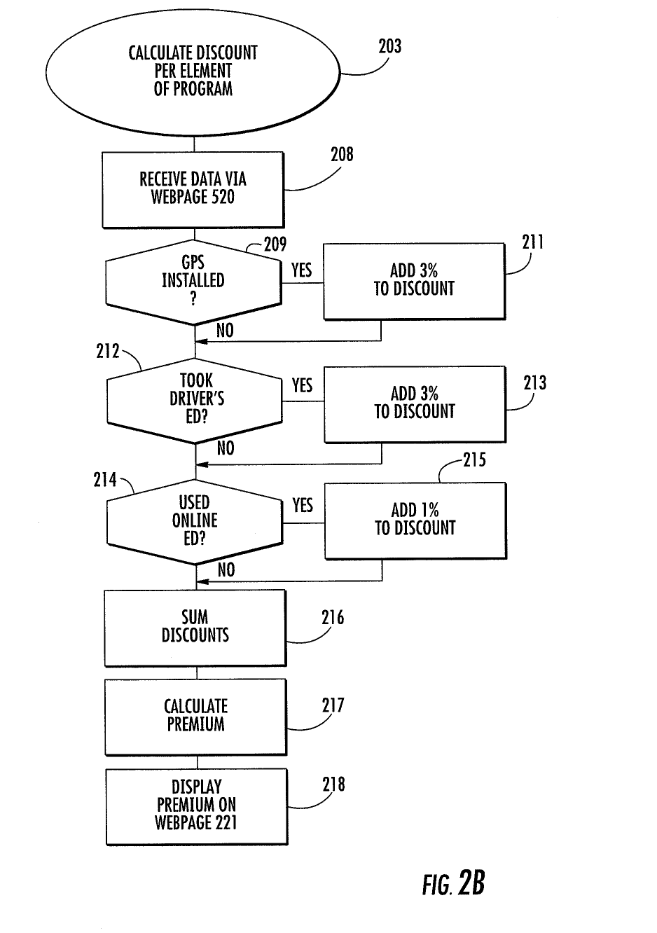

In various embodiments, the amount to be discounted depends on the level of participation in the young driver program 100 by the young driver and his or her parent, guardian, and/or policyholder. In particular, in one embodiment, which is illustrated in FIG. 2, the insurance company may provide a premium discount based on the sum of one or more particular discount amounts associated with respective elements of the young driver program 100 in which the young driver and/or his or her parent, guardian, and/or policyholder participate. Beginning with Step 201, the young driver program 100 identifies which elements of the young driver program 100 are being utilized by the young driver and/or his or her parent, guardian, and/or policyholder. In response to identifying one or more elements being utilized, the insurance company holding the policy for the young driver awards the policyholder a premium discount based on the one or more elements utilized, which is shown as Step 203. As one example, according to a particular embodiment, the insurance company may offer a 3% discount if the GPS system 102 is installed in the young driver's vehicle, a 3% discount if the young driver participates in the drivers' education course 101, and a 1% discount if the young driver and his or her parent, guardian, and/or policyholder utilize the online resource tools 104, resulting in a 7% discount for participating in all three elements of the young driver program 100. However, if the young driver does not utilize the online resource tools 104 but participates in the other two elements, the premium discount is 6%.

An example of a software algorithm for implementing such a discount plan is shown in FIG. 2B, according to which at Step 208 the young driver system receives data entered by the user on webpage 520 (described below) pertaining to a young driver's automobile, personal information, insurance coverage choices, and utilization of elements of the young driver program 100. At Step 209, the young driver system determines from the data whether or not the user has installed the GPS system 102. If so, at Step 211, 3% is added to the user's premium discount. If not, no discount is provided, and the young driver system proceeds to Step 212 to determine from the data whether or not the user has taken the drivers' education course 101. If so, at Step 213, 3% is added to the user's discount. If not, no discount is provided, and the young driver system proceeds to Step 214 to determine from the data whether or not the user has utilized online educational materials 104. If so, at Step 215, 1% is added to the user's discount. If not, no discount is provided, and the young driver system proceeds to Step 216 where the assigned discounts are totaled. In this example, the total discount may range from 0% to 7%. After calculation of the discount, the young driver system at Step 217 calculates a premium for quotation using the insurance carrier's normal practice in a well known manner, and displays at Step 218 a premium quote and user data for confirmation on webpage 521.

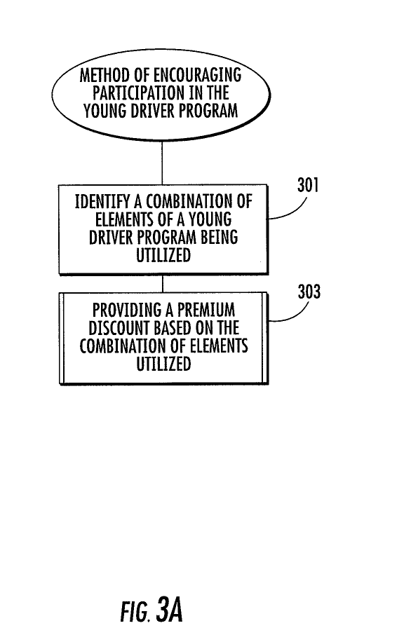

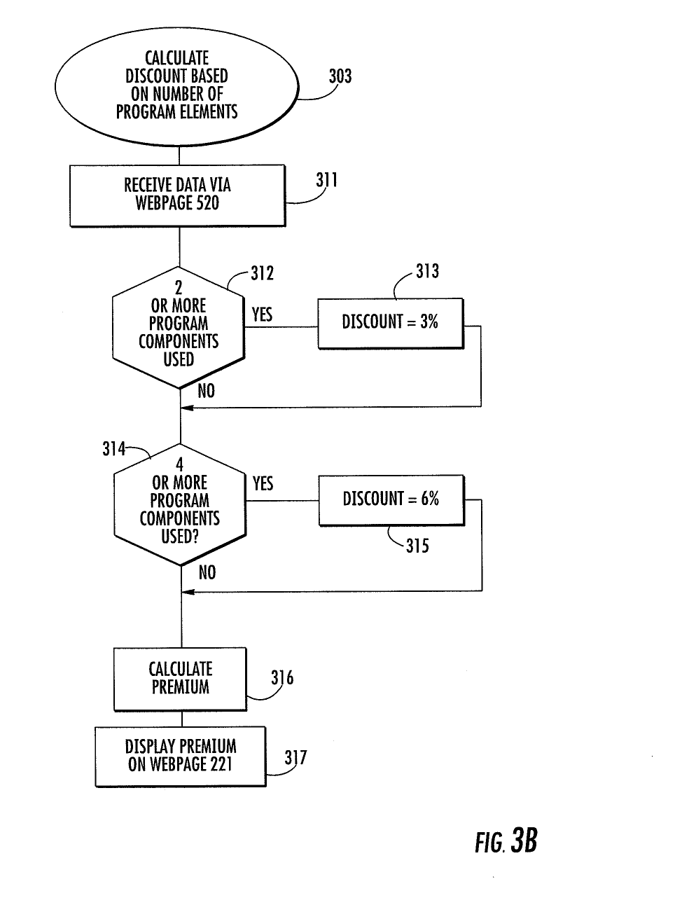

In another embodiment, which is shown in FIG. 3, the insurance company may associate a discount amount for certain combinations of elements of the program 100. Beginning with Step 301, the young driver program 100 identifies which combination of elements of the young driver program 100 is being utilized by the young driver and/or his or her parent, guardian, and/or policyholder. In response to identifying the combination of elements being utilized, the insurance company holding the policy for the young driver awards the policyholder a premium discount based on the combination of elements utilized, which is shown as Step 303. For example, the insurance company may offer a 3% discount if the young driver participates in two of six available elements of the program 100 or a 6% discount if the young driver participates in four of eight available elements of the program 100. In another embodiment, participants in the young driver program 100 receive a certain discount for just being participants in the young driver program 100 (e.g., a 5% discount for participating in the young driver program 100).

An example of a software algorithm for implementing such a discount plan is shown in FIG. 3B, according to which at Step 311 the young driver system receives data from webpage 520 (described below) pertaining to a young driver's automobile, personal information, insurance coverage choices, and utilization of elements of the young driver program 100. At Step 312, the young driver system determines from the data whether or not the user has utilized two or more components of the young driver program 100. If so, at Step 313, the user's discount is set at 3%. If not, no discount is provided, and the young driver system proceeds to Step 314 to determine from the data whether or not the user has utilized four or more components of the young driver program. If so, at Step 315, the discount is set at 6%. If not, no change is made in the discount, and the young driver system proceeds to Step 316 where the premium is calculated using the assigned discount as discussed above. Then at Step 317 the young driver system displays a premium quote and user data for confirmation on webpage 521.

In addition, according to yet another embodiment of the invention, the insurance company may provide a premium discount if the young driver follows the GPS system-related rules set by the parent, guardian, policyholder, third party program sponsor, and/or the insurance company during a particular time period (e.g., a month, or a policy period). For example, if the young driver does not drive outside of the geofence during the policy period, the policyholder is provided a premium discount (e.g., between about 0.5% and 5%). Similar to the discount schemes discussed above in relation to FIGS. 2 and 3, the insurance company may provide the policyholder with a premium discount based on the level of compliance with the GPS-related rules.

Premium discounts may be applied either prospectively to future policy periods, or retrospectively to the policy period in which the awarded behavior occurs.

In embodiments of the invention, a calculator forming part of the computer implemented young driver system as described below receives an insurance company's standard pricing for the driver on whom a policy exists or would be written, and subtracts a discount determined in various ways as described above.

### Discounts on Car Purchases and Leases

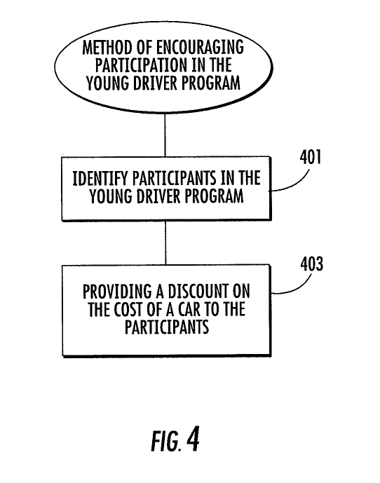

According to various embodiments of the invention, the sponsor of the young driver program 100 may provide a discount for car purchases or leases made by participants of the young driver program 100. In one embodiment, such as the embodiment shown in FIG. 4, participants in the young driver program 100 receive a discount for being participants in the young driver program 100. In Step 401, participants of the young driver are identified, and in response to identifying participants in the young driver program 100, a discount that can be applied toward the cost of a car to the participants is provided to the participants, which is shown as Step 403. For example, in a particular embodiment, the participants receive a discount of between about 0.5% and about 5% off of the cost of a car by joining the young driver program 100.

In another embodiment, the amount of the discount is based on the level of participation in the young driver program 100 by the young driver and/or his or her parent, guardian, and/or policyholder. For example, in a particular embodiment, the cost of the car is discounted by between about 0.5% and about 5% for each element of the young driver program 100 utilized. As a specific example, according to one embodiment, a young driver receives a 15% discount on the cost of a car if the young driver has agreed to install the GPS system 102 in his or her car, has agreed to take the drivers' education course 101, and has accessed two of four online resources 104. In another embodiment, the discount on the cost of the car is based on the combination of elements utilized.

### Exemplary Website for Young Driver Program

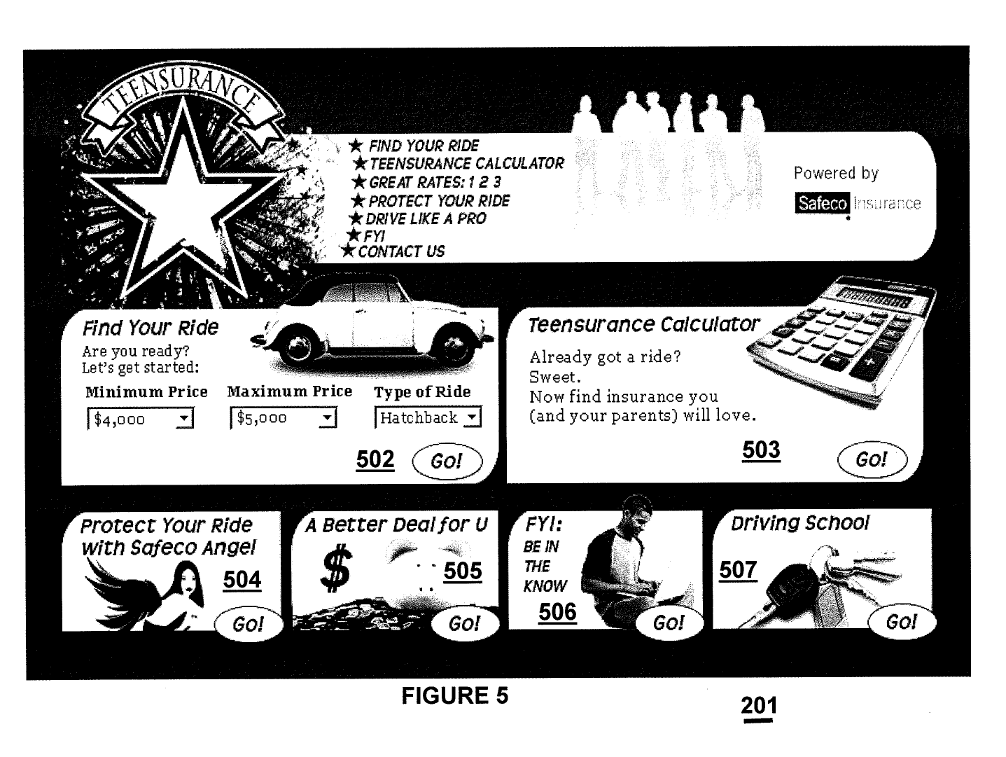

FIG. 5 is a graphic illustration of an exemplary home webpage 501 of a website associated with the young driver program 100 according to one embodiment of the invention. As shown, the home webpage 501 provides links to information and tools associated with various elements of the young driver program 100. As shown in FIGS. 5-15, the information and tools are provided on webpages accessible to users over the Internet using a user devices such as web browers via links to the home webpage in a well known manner. Such links are also shown in FIG. 1. Such linked web browsers run on computers linked by the Internet, the computers having associated memory modules for data storage, as is well known in the art, and in this exemplary embodiment provide, as shown in FIGS. 1 and 5-15, a young driver system that embodies the young driver program 100. For example, the home webpage 501 provides an interface 502 for the car research tool 107, a link 503 to access an interface for the for the insurance price optimizer tool 106, a link 504 to access an interface of the GPS system 102, a link 505 to the information related to the young driver rewards program 103, a link 506 to additional online resources 108 related to the driving experience, and a link 507 to information about the drivers' education course 101.

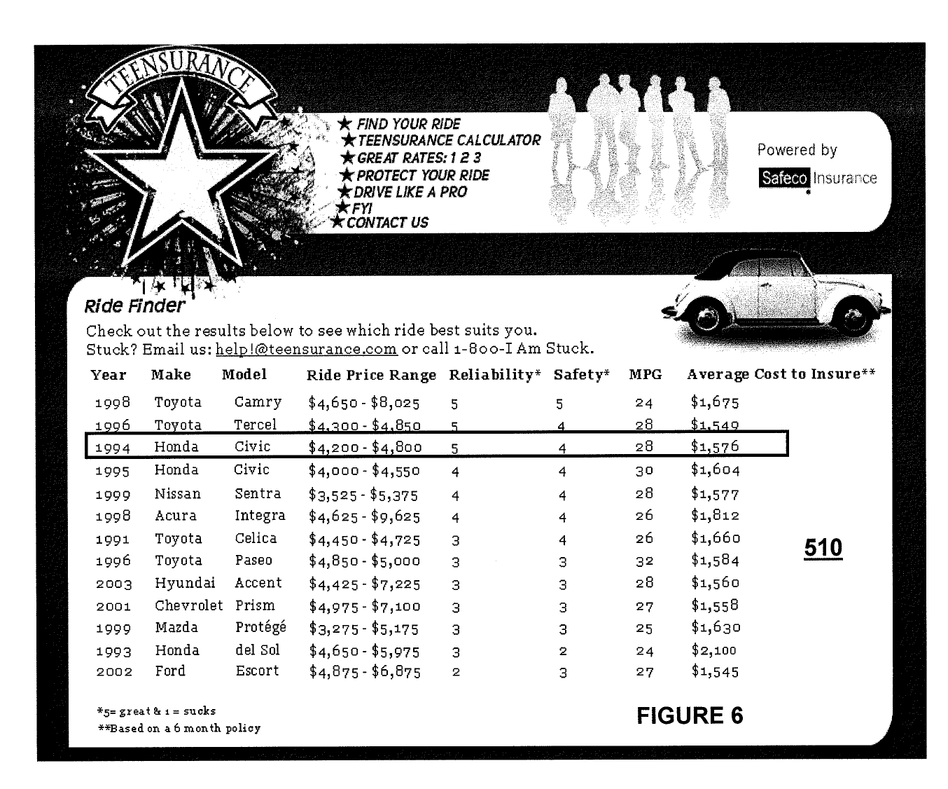

For example, a user of the website may utilize the car research tool 107 by entering various criteria into the interface 502 to search for cars that meet the criteria. In one embodiment, for example, the user may enter a minimum price, a maximum price, and a type of ride in which the user is interested (e.g., hatchback, sedan, SUV, sport, or convertible). Vehicles meeting the criteria are then displayed for the user. For example, the results may be displayed on a car research results webpage such as the webpage 510 shown in FIG. 6. In the embodiment shown in FIG. 6, the car research results include a listing of one or more vehicles meeting the requested criteria, ratings related to the reliability and safety of each vehicle, average miles per gallon of each vehicle, average price ranges for each vehicle, and an average cost to insure each vehicle. In various other embodiments, additional information that may be important to a potential car purchaser may be displayed.

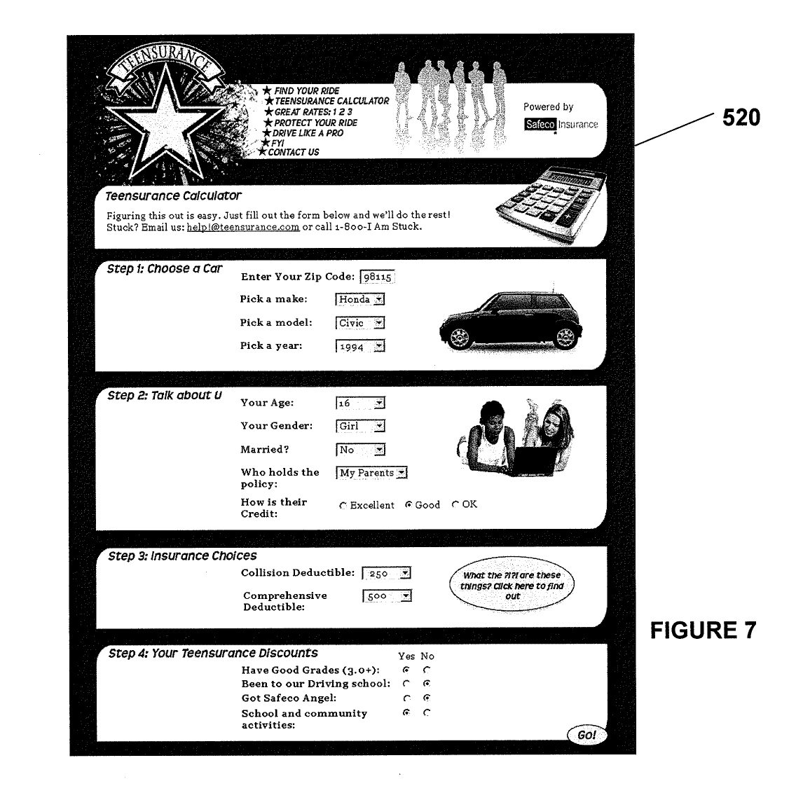

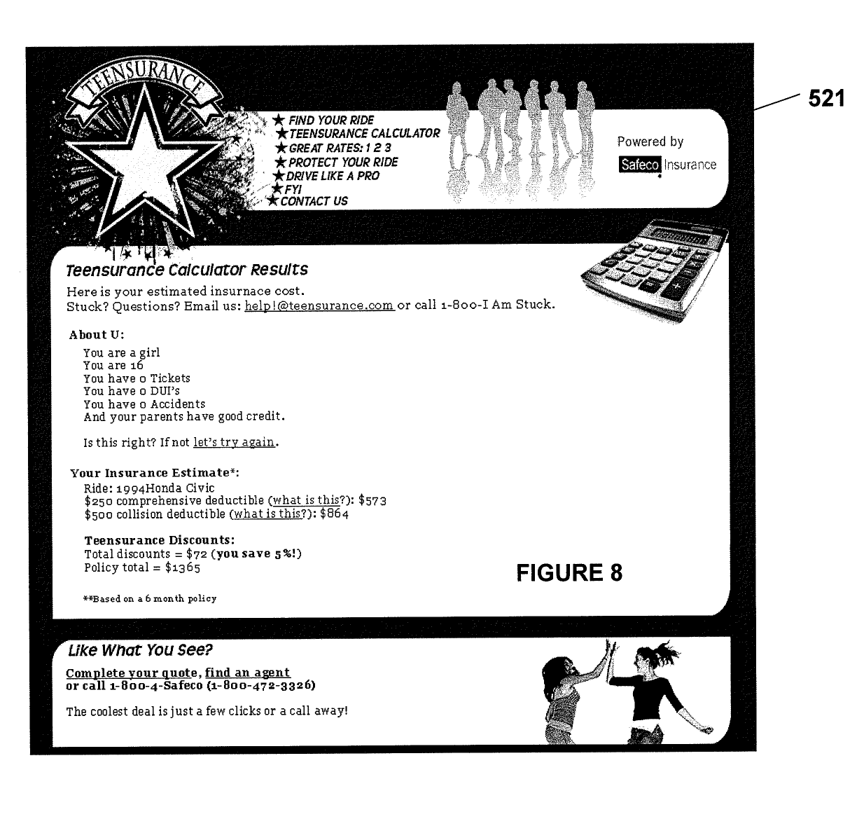

In another example, the user may utilize the insurance price optimizer tool 106 by selecting the link 503 to the tool 106. Upon selection of the link 503, a webpage such as the exemplary webpage 520 shown in FIG. 7 is displayed for entering information potentially relevant to the cost of insuring a vehicle. For example, the webpage 520 allows the user to enter (or select) the make, model, and year of a vehicle to be insured, a zip code of the user, the user's age, gender, and marital status, the relationship of the policyholder to the young driver, and an estimation of the policyholder's credit history (e.g., excellent, good, or okay). In addition, the webpage 520 allows the user to select a deductible amount for collision and/or comprehensive coverage. Furthermore, the webpage 520 allows the user to select whether the young driver has good grades, has attended the drivers' education course 101, and whether the young driver is involved in school or community activities, for example. Some of these selections indicate participation in aspects of the young driver program 100 for obtaining discounts on the cost of insurance as described above. The input information is then used to estimate a cost of insurance based on the information, and the cost estimation is shown on a webpage such as the exemplary webpage 521 shown in FIG. 8. The user can return to the webpage 520 and change information to determine how each piece of information affects the cost of insurance. The webpages 520 or 521 or both can be located on an insurance company's website or a website.

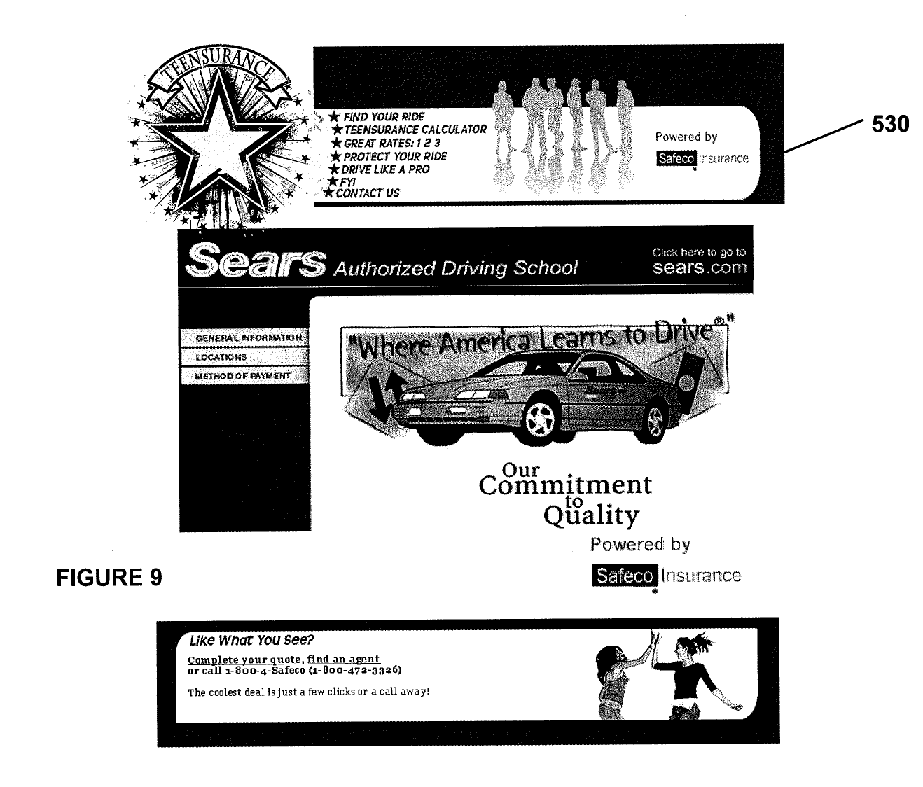

In another example, the user of the website may choose to view information related to the drivers' education course 101 by selecting the drivers' education course link 507. Upon selecting the link 507, a webpage such as the exemplary webpage 530 shown in FIG. 9 is displayed that provides information and links to additional information regarding the drivers' education course 101.

In addition, the user of the website may choose to access the GPS system 102 through the website by selecting the GPS system link 504. Upon selection of the link 504, a webpage such as the exemplary webpage 540 shown in FIG. 10 is displayed to the user with a list of vehicles that contain GPS units that are part of the GPS system 102. The webpage 540 displays the name of a primary driver listed for the vehicle, the make, model, color, and year of the vehicle, license plate information, the number of communications to or from the GPS unit, whether the geofencing function is on or off, whether the speed limit monitoring function is on or off, and the date and time of the last report requested by the user. In addition, the user can select whether to view the history log or service log or edit the service log, the configuration, or the vehicle control aspects of the GPS system 102 for each vehicle listed.

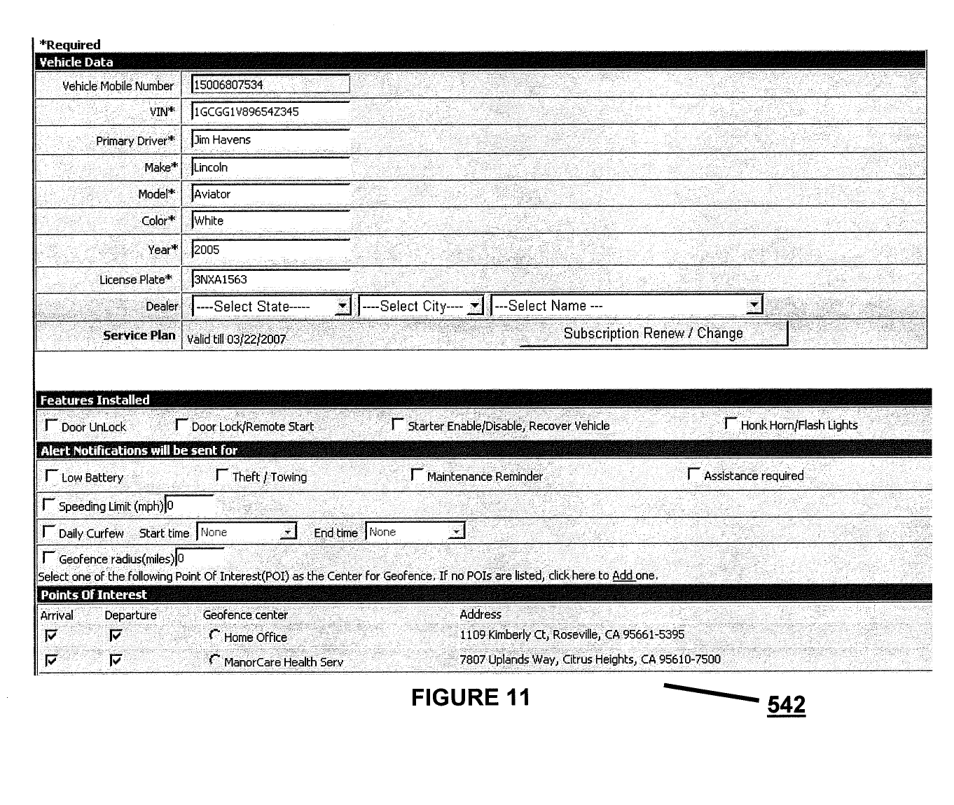

FIG. 11 illustrates an exemplary webpage 542 that allows the user to enter or edit vehicle data associated with a vehicle within which a GPS unit is installed. In particular, the webpage 542 allows the user to enter a vehicle identification number (VIN), an identity of a primary driver, the make, model, year, and color of the vehicle, a license plate number, and a dealer for the GPS unit installed in the car. In addition, the webpage 542 allows the user to select and activate certain features of the GPS system 102, such as unlocking the doors from a remote location, starting the vehicle from a remote location, enabling or disabling the starter from a remote location, or causing the horn to honk or the lights to flash from a remote location. Furthermore, the webpage 542 allows the user to select when the user wants to receive alert notifications. For example, the user may choose to be notified if the battery of the GPS unit is low, if the vehicle is being operated by an unauthorized user or is being towed, if maintenance is needed or scheduled, if assistance is required or requested, if the driver operates the vehicle over a certain speed, if the driver drives outside of set time period or curfew, and/or if the driver drives outside of a predefined geofence or within a particular radius of certain points of interest (e.g., home, office, or school). Furthermore, the webpage 542 allows the user to set the certain speed limit, set the time period during which the vehicle is allowed to be operated, and define the geographical area subject to the geofence.

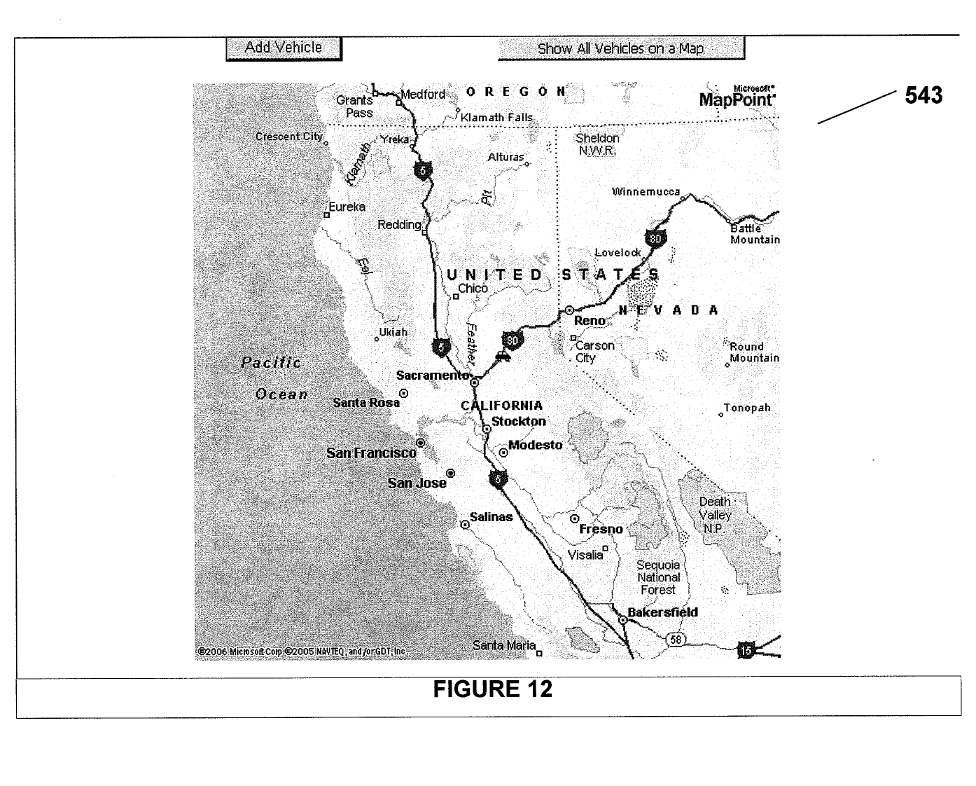

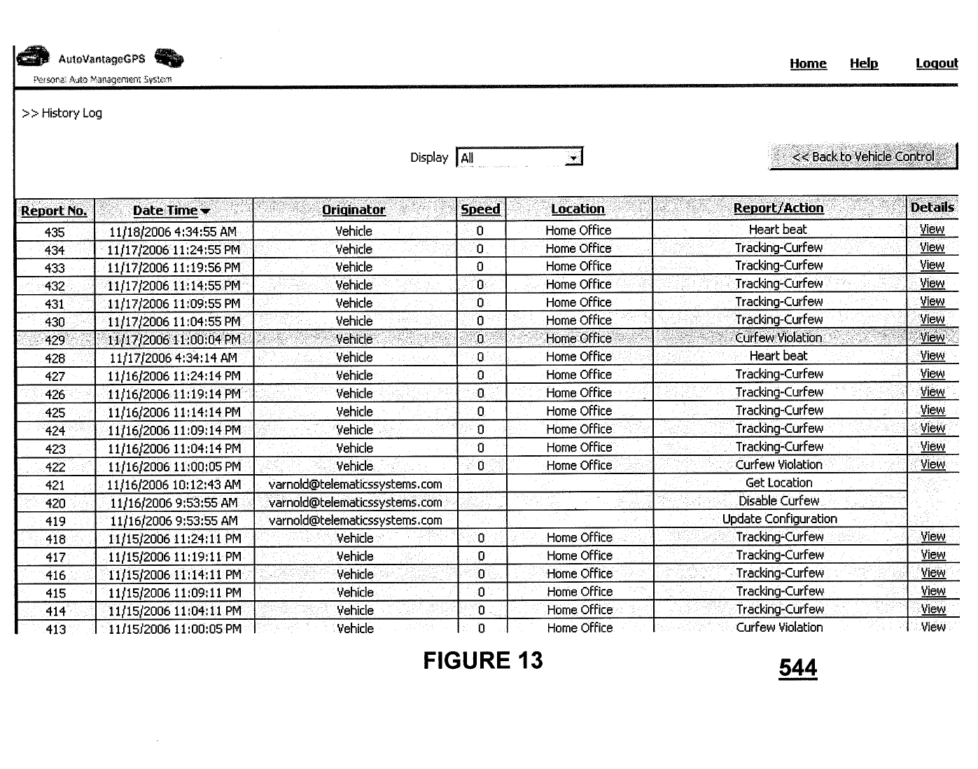

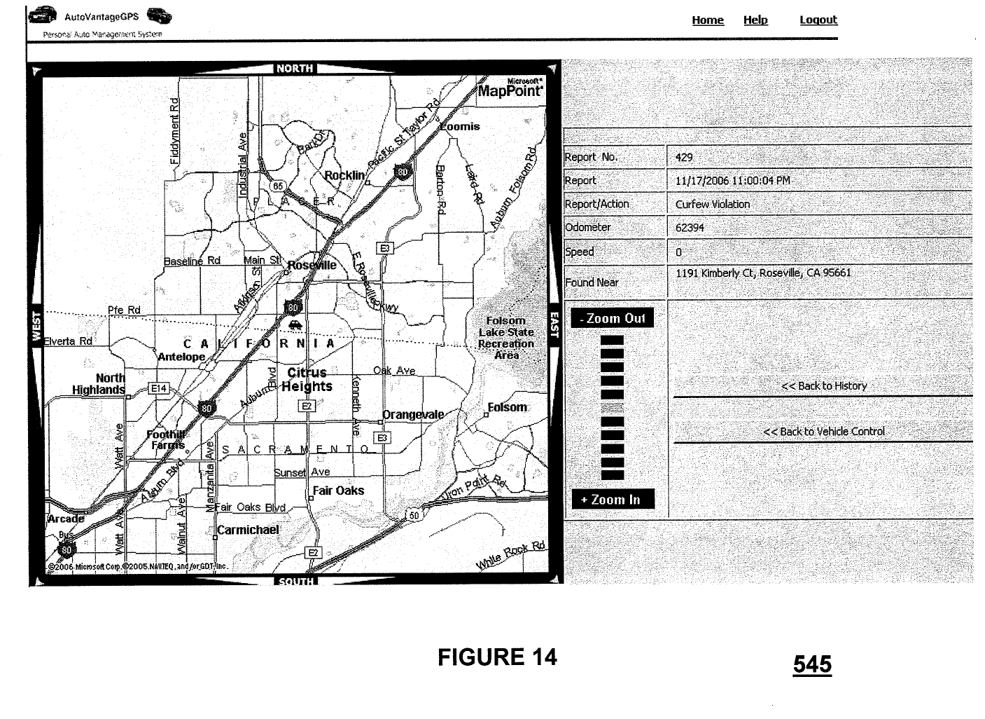

FIG. 12 illustrates an exemplary webpage 543 that displays the current location of the vehicle on a map. In addition, FIG. 13 illustrates an exemplary webpage 544 that displays a history log of communications between the vehicle's GPS unit and the receiver of the GPS system 102. The history log tracks the date and time of each communication, the source of the communication, the speed of the vehicle at the time of the communication, the location of the vehicle at the time of the communication, the type of communication or reason for the communication, and a link to view a webpage, such as the exemplary webpage 545 shown in FIG. 14, that displays the location of the vehicle on a map at the time of the communication.

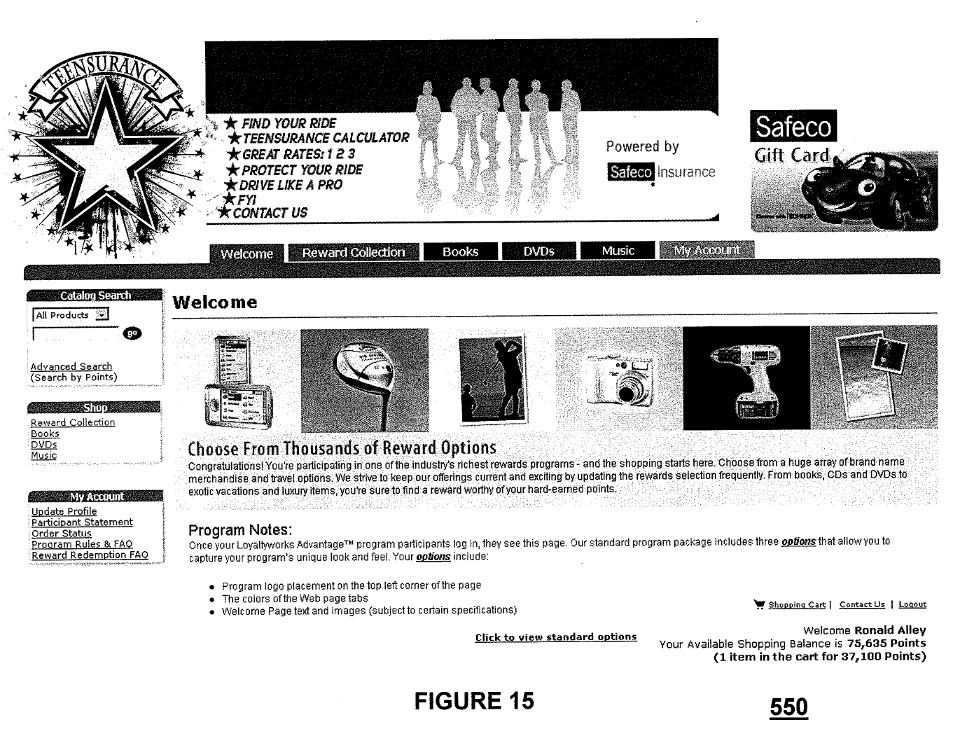

Furthermore, the user may select link 505 to access information regarding the rewards program 103. In response to the link 505 being selected, a webpage such as the exemplary webpage 550 shown in FIG. 15 is displayed for the user with information related to the rewards program 103. For example, in the embodiment shown in FIG. 15, the user can browse or search a catalog of products and/or services that may be obtained in exchange for reward points earned by the young driver. Furthermore, in the embodiment shown in FIG. 15, the user can check his or her point balance.

### Program Managing and Underwriting System

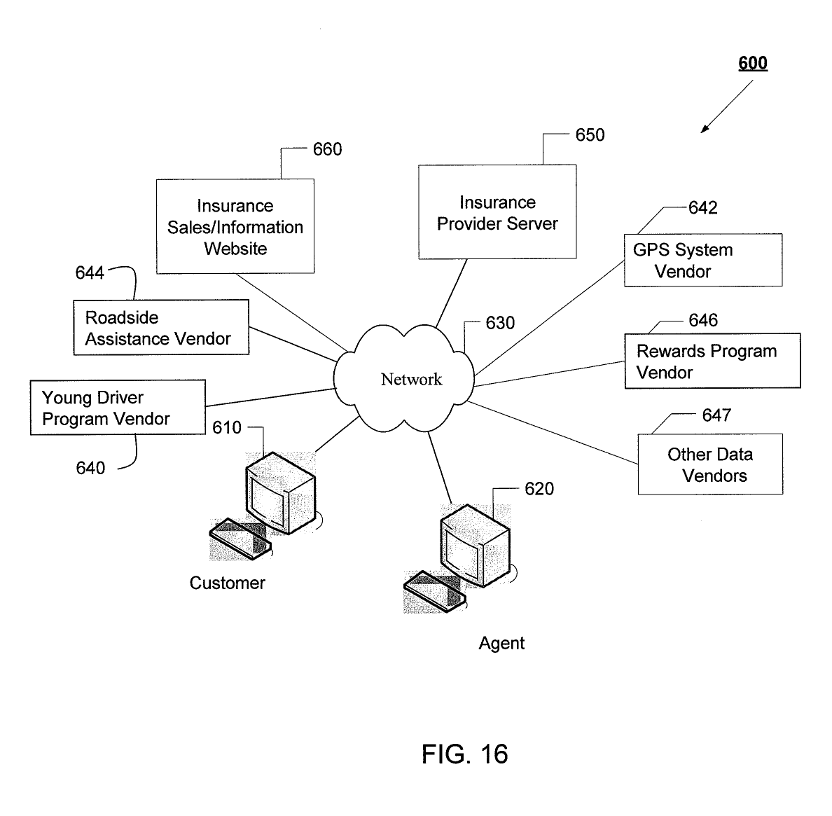

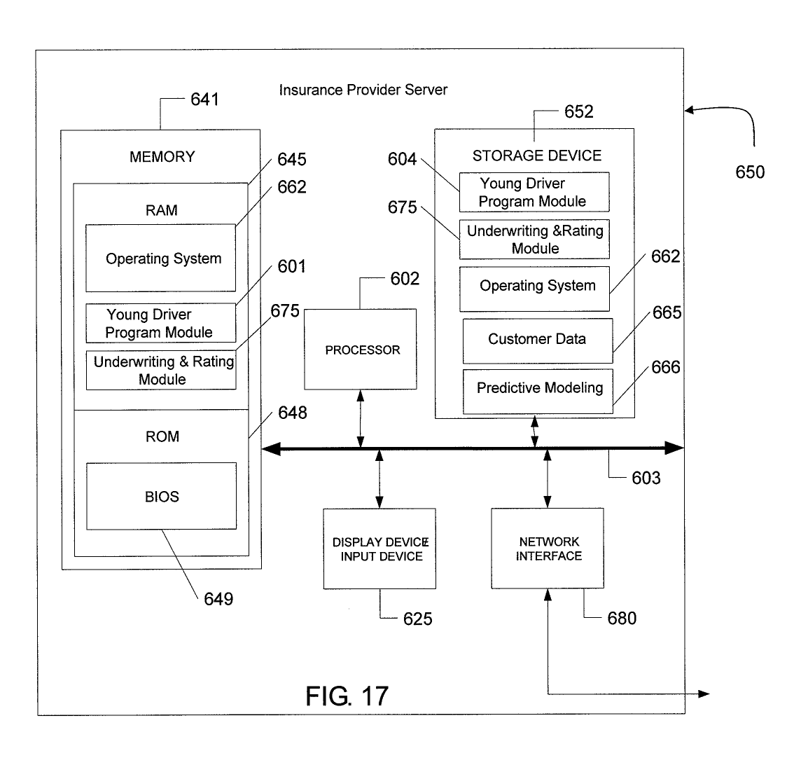

FIG. 16 provides a block diagram of a system 600 for providing a young driver program 100, in accordance with various embodiments of the present invention. As may be understood from this figure, the system 600 may include one or more computing devices 610, 620, which may be used, for example by a customer or an advisor to access an insurance sales or information website 660 via a network 630 (e.g., a Local Area Network (LAN), wide area network (WAN), the Internet, or the like) for the purpose of buying or receiving quote information or recommendations for one or more insurance products, and/or for renewing or modifying an existing insurance product. Either or both computing device 610, 620 may include, for example, a personal computer (PC), laptop, personal digital assistant (PDA), cellular telephone, or similar electronic device. According to one exemplary embodiment, the insurance sales/information website 660 may be operated by an insurance provider server 650 by way of the same or a different network 630. In particular, as discussed in more detail below, the insurance provider server 650 of one exemplary embodiment may be configured to execute a young driver program module 604 and an underwriting and rating module 675, shown in FIG. 17, in order to generate and provide underwriting conclusions with regard to a customer. Such conclusions may be used internally by the insurance provider or may be shared with a customer or advisor by way of the insurance sales/information website 660. In other embodiments, the insurance sales/information website 660 may be operated by a third party for the purpose of allowing a customer or advisor to interface with systems of an insurance provider.

The system 600 may further include a server or website 640, maintained by a young driver program vendor; it should be understood that the young driver program 100 can be provided either by the insurance provider server 650 or by a system 640 of a vendor. The system 600 may further include a server or website 642 maintained by a GPS system vendor, for carrying out monitoring and other functions described above. The GPS vendor system 642 is accessible by or communicates with the insurance provider server 150 via the network 630 for the purpose of sharing information needed to generate underwriting conclusions in accordance with embodiments of the invention. In particular, in one exemplary embodiment, the GPS vendor system 642 stores information recording subscriptions of customers to the GPS monitoring services, including installation of a GPS device in a vehicle, and activation of the device for monitoring the vehicle.

When a customer or a customer's agent applies for a discount based upon use of the GPS system, for example using the insurance sales/information website 660, the underwriting and rating module 675 may be configured to send an inquiry via the network 630 to the GPS system 642 to determine or confirm whether the customer has installed and activated a GPS unit in the insured vehicle. On confirmation, the underwriting and rating module 675 may be configured to apply a predetermined discount to the customer's premium. The discount may be applied in response to confirmation of installation of the GPS unit, or activation may also be required. In the alternative, the GPS system 642 may regularly send customer installation and activation information to the insurance provider server 650 via the network 630, to be stored there, for example in the memory 641 or in the customer data database 665 described below. The underwriting and rating module 675 may be configured to access the stored data for confirmation of installation and/or activation of the GPS unit in response to a request for a discount, and to apply a discount associated with such action by the customer when the action is confirmed by the data received from the GPS system. In a further alternative embodiment, the underwriting and rating module 675 may be configured to utilize the data from the GPS system upon, or soon after, its receipt at the insurance provider server 650, to apply the discount without a customer request. When a discount is applied in accordance with one of the foregoing embodiments, the insurance provider server may optionally be configured to notify the customer or the customer's agent via any of several means, such as posting at the website 660, email, text messaging, facsimile, telephone, or postal mail.

The system 600 may further include a server or website 644, maintained by a roadside assistance vendor, for carrying out the roadside assistance program 109 described above, and a server or website 646 maintained by a rewards program system vendor, for carrying out the rewards program 103 described above. The system 600 also may provide access to one or more other data sources represented by the other data vendors 644 in FIG. 16. These external data sources 644 may provide the online resources 104 described above and also data for various purposes such as coverage recommendations, underwriting, or preparing risk models.

FIG. 17 provides a schematic diagram of the insurance provider server 650 according to one exemplary embodiment of the invention. As shown, the insurance provider server 650 may include a processor 602 that communicates with other elements within the insurance company server 650 via a system interface or bus 603. The processor 602 could be, for example, a central processing unit, microprocessor, microcontroller, programmable gate array, or some other device that processes data. Also included in the insurance provider server 650 of this exemplary embodiment is a display device/input device 625 for receiving and displaying data. The unit 625 may include, for example, an input device such as a keyboard, mouse or pointing device, and a display device such as a monitor, cathode ray tube (CRT), liquid crystal display (LCD), or other such device. The insurance provider server 650 may further include a memory 641, which includes both random access memory (RAM) 645 and read only memory (ROM) 648. The computer's ROM 648 may be used to store a basic input/output system 649 (BIOS), containing the basic routines that help to transfer information between elements within the insurance provider server 650.

In addition, the insurance provider server 650 may include at least one storage device 652, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 652 is connected to the system bus 603 by an appropriate interface. The storage devices 652 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules comprising, for example, one or more computer-readable program code portions executable by the processor 602, may be stored by the various storage devices 652 and within RAM 645. Such program modules may include an operating system 662, a young driver program module 604, an underwriting and rating module 675, and a predictive modeling module 666. The young driver program module 604, predictive modeling module 666, and the underwriting and rating module 675, control certain aspects of the operation of the insurance provider server 650, as is described in more detail herein, with the assistance of the processor 602 and the operating system 662. If the young driver program 100 is provided by the insurance provider, then the young driver program module 604 contains software needed to present and administer the program 100 as described herein. If the young driver program is provided by the vendor system 640, then the young driver program module 604 of the server 650 provides functions, such as transfer of data, needed to interface the server 650 with the vendor server or website 640.

The storage device 652 may also include a database 665 of customer data for customers of the insurance provider, such as policy information and underwriting information, including the values of the factors used in preparing risk models. In the alternative, the customer data may be stored in another device elsewhere on the network. For example, the customer data may be stored on a separate server (not shown) connected via the network 630 to the insurance provider server 650. The customer data may be referred to herein as “internal data” whether it is stored on the insurance provider server 650 or elsewhere under the control of the insurance provider. Similarly, the database 665, wherever located, is referred to herein as an “internal data source.” Additional internal data sources may be provided.

Also located within the insurance provider server 650 is a network interface 680, for interfacing and communicating with other elements of a computer network, such as the elements shown in FIG. 16. It will be appreciated by one of ordinary skill in the art that one or more of the insurance provider server 650 components may be located geographically remotely from other insurance provider server 650 components. Furthermore, one or more of the components may be combined, and additional components performing functions described herein may be included in the insurance provider server 650.

From the foregoing it may be seen that a young driver program in accordance with embodiments of the present invention enhances the new driver experience for young drivers and their parents, guardians, and/or policyholders by providing tools to encourage young drivers to drive safely and consolidating information on topics of interest to young drivers and their parents, guardians, and/or policyholders. The young driver program offers a unique compilation of tools designed to help young drivers navigate the process of learning to driver, getting a car, and finding the right insurance policy with all possible associated discounts. In addition, the present invention tends to increase the number of automobile insurance policies written to a young driver segment of a population, by providing a young driver program for young drivers and/or their parents, guardians, and/or policyholders; and in response to participation by a young driver and his or her parent, guardian, and/or policyholder, providing a premium discount to the policyholder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. A web-based system for providing services related to automobile safety and an insurance product, comprising:
a web site comprising a home web page configured to provide links to one or 5 more web pages accessible by a user over the Internet, the one or more web pages being configured to provide at least two elements selected from:
an interface to a GPS vehicle monitoring system connected to provide vehicle information to the user via one or more of the web pages and to receive instructions from the user to select features of the GPS system;
at least one of a display of or link to educational information relating to safe driving, stored by the web-based system or provided by interface to a third party web site; or
an interface to a roadside assistance system.

2. The system of claim 1, wherein the website further includes:
at least one of a display of or link to a tool providing an estimate of an insurance premium discount based on use of one or more of the elements.

3. The system of claim 2, wherein compliance includes one or more of: use of one or more of the web pages; use of the GPS system, or compliance with a driver safe behavior agreement.

4. The system of claim 2, wherein the elements from which the at least two elements are selected further include:
at least one of a display of or link to guidelines for driver behavioral standards; an interface to a drivers education course provider; or
an interface to a rewards program based on compliance with driver behavioral standards.

5. The system of claim 1 wherein the GPS system is configured for providing third parties, insurance companies, and/or program participants with information relating to a location of a vehicle, providing an ability to unlock a door of the vehicle remotely, and providing an alert if the vehicle travels outside of a predefined geofence or is operated without authorization.

6. The system of claim 5, wherein the GPS system includes a GPS receiving system linked to the vehicle over a network and configured to receive data from the vehicle and to display a map of the vehicle's position.

7. The system of claim 1 wherein the premium discount increases in proportion to the level of use of the elements by a driver, a driver's parent, guardian, and/or a policyholder.

8. The system of claim 1 wherein the premium discount depends on the combination of elements utilized by a driver, a driver's parent, guardian, and/or a policyholder.

9. The system of claim 1 wherein the premium discount depends on the particular one or more elements utilized by a driver, a driver's parent, guardian, and/or a policyholder.

10. The system of claim 1, wherein the tool includes an interface for receiving user information useful for calculating an insurance premium and an insurance premium calculator.

11. A system for providing an insurance price estimate, comprising:
an interface for receiving user information used for calculating an insurance premium, the user information including presence or absence of user participation in one or more elements of a driver program, the program elements including one or more of: driving safety information, an accident scene management plan, a roadside assistance plan, a car research tool, a driver education course, a safety rewards program, or a GPS data gathering system;
a computer based pricing tool configured to output an estimated insurance premium based on the user information; and
a user accessible display of the estimated insurance premium output by the pricing tool.

12. The system of claim 11, wherein the pricing tool is configured to store discount percentages attributed to participation is each of the elements of the driver program, and to vary the estimated premium based a sum of the discounts associated with the elements in which the user participates.

13. The system of claim 11, wherein the pricing tool applies a premium discount according to the number of program elements in which the user participates.

14. A computer-implemented method of promoting the sale of vehicular insurance policies written on a selected segment of a population, said method comprising the steps of:
providing a user interface via a network a driver program running on a computer system, the program providing for one or more drivers from a selected segment of a population (1) an interface to a monitoring system configured for collecting data associated with a vehicle to be driven by one of the one or more drivers; and (2) one or more online resources for providing information relating to driving by the selected segment of the population; and
in response to participation by one of the drivers in the program, providing an estimated premium discount to a customer for an insurance policy on the driver.

15. The method of claim 14, wherein the customer is one of the driver or a third party.

16. The method of claim 14, wherein the estimated premium discount is provided responsive to participation in the program by a family member, guardian, or a policyholder associated with the driver.

17. (canceled)

18. The computer program product of claim 28, wherein the selected segment of the population comprises persons 15 through 24 years of age.

19. The computer program product of claim 18, wherein the educational information includes an interface to a roadside assistance plan.

20. The computer program product of claim 18, wherein the educational information includes
an interface to a drivers' education course vendor;
an interface to a rewards program vendor, wherein the rewards program rewards drivers for safe driving habits or for participation or achievements related to various parts of the driver program; and
an interface to an accident scene management provider.

21. The computer program product of claim 18, wherein the educational information comprises:
an insurance price optimizer tool configured to provide ways to reduce the cost of automobile insurance for drivers in the segment;
a car research tool configured to identify costs associated with owning or leasing one or more types of vehicles; and
one or more articles relating to driver safety.

22. A computer system for providing an insurance premium discount, comprising:
an underwriting and rating module configured to:
receive, from a monitoring system in communication with an insured customer's vehicle, data indicating whether the vehicle has installed therein a monitoring device for sending information to the monitoring system; and
apply a discount to the customer's premium in response to confirmation of installation of the monitoring device without regard to content of information from said monitoring device.

23. The system of claim 22, further comprising:
a user accessible display of the calculated discount or an insurance premium output by the underwriting and rating module.

24. The system of claim 22, wherein the underwriting and rating module is configured to apply the discount further in response to confirmation of activation of the monitoring device.

25. The system of claim 22, wherein the data from the monitoring system is received and stored in a data storage device of an insurance provider server and received by the underwriting and rating module from the data storage device.

26. The system of claim 22, further comprising:
an interface for receiving a request for a discounted insurance premium from a customer.

27. The system of claim 22, wherein the underwriting and rating module is further configured to:
provide to a computing device of a driver associated with the insured customer a website offering educational information relating to driving;
receive access data from the computing device responsive to the educational information being accessed; and
apply an additional discount in response to receipt of the access data.

28. A computer program product, comprising a non-transitory computer readable storage medium having recorded thereon a computer executable program, wherein the program instructs a processor to:
provide via a network to a computer device, a user interface to a monitoring system configured for collecting data associated with a vehicle;
provide a website offering educational information relating to driving by a selected segment of the population to the computer device;
receive access data from the computing device responsive to the educational information being accessed by a driver associated with the vehicle and belonging to the selected segment of the population;
receive installation data from the computing device responsive to the monitoring system being accessed via the user interface; and
in response to receiving the access data, without regard to content of data collected by the monitoring system, determine by the processor and send to the computing device an estimated premium discount for an insurance policy on the driver.
